(19) United States
(12) Patent Application Publication
(10) Pub. No.: US 2026/0049587 A1
(43) Pub. Date: Feb. 19, 2026

(54) EMISSION REDUCTION

(71) Applicant: Yusuf ABERLE, Erfurt (DE)

(72) Inventor: Yusuf ABERLE, Erfurt (DE)

(21) Appl. No.: 19/303,452

(22) Filed: Aug. 19, 2025

(30) Foreign Application Priority Data
Aug. 19, 2024 (EP) 24 195 220.9

(51) Int. Cl. F02M 27/04

(52) U.S. Cl. CPC F02M 27/045; F02M 2200/9007

(57) ABSTRACT

The invention relates to a device for optimizing fuel combustion in combustion engines comprising a housing, a top cover having a grommet for connection with a fuel line, a bottom cover having a grommet for connection with a fuel line, a first ceramic element having a multitude of bores, at least one second ceramic element having a contorted through channel, and a magnetic zone with a multitude of magnetic elements and a multitude of spring colls, both arranged alternate and longitudinally.

### RELATED APPLICATION(S)

This application claims the benefit of priority of Europe Patent Application No. 24 195 220.9 filed on Aug. 19, 2024. The contents of the above application are all incorporated by reference as if fully set forth herein in their entirety.

### FIELD AND BACKGROUND OF THE INVENTION

The invention relates to a device for optimizing fuel combustion in combustion engines comprising a multitude of ceramic elements and a magnetic zone.

Today, there exist a great number of protective rights and studies on fuel saving and emission reduction concerning diesel and petrol vehicles. The devices used in these studies differ in terms of working principle, size, materials and fields of use. These differences have a direct impact on production costs and performance.

WO 2009/102285 A1 describes a fuel saving system based on the principle of magnetic field generation with copper wire windings. However, the disadvantage of this method is a need for a continuous energy supply and also the partial distortion of the magnetic field as a result of energy fluctuations that may occur in the energy source.

In another study rectangular prism magnets are fixed in a fuel saving device. The number of magnets is low and size is large, which results in a limited performance and great space requirements.

In further studies the fuel coming from the fuel filter enters the device through the top cover and is not sufficiently exposed to the magnetic field, or the device is too far removed from the fuel passage.

EP 2 218 898 A1 discloses a magnetic device to apply opposed magnetic fields to a fuel flow, four magnets being situated at angles of 90° around the fuel line.

All these disclosures suffer from various drawbacks, which are detrimental to their use in everyday practice.

### SUMMARY OF THE INVENTION

It is an object of the present invention to provide an improved device for optimising fuel combustion in combustion engines, both diesel and petrol engines.

This object is achieved with a device comprising a housing, a top cover having a grommet for connection with the fuel line, a bottom cover having a grommet for connection with the fuel line, a first ceramic element having a multitude of bores, at least one second ceramic element having a contorted through channel, and a magnetic zone with a multitude of magnetic elements and a multitude of spring coils, both arranged alternate and longitudinally.

The present device is preferably inserted into a fuel line between the fuel filter and the fuel pump of a combustion engine.

The present device relates to motor vehicles running on gasoline and diesel fuel. The device is positioned between the fuel pump of the motor vehicle and the fuel filter. Fuel saving and emission reduction is achieved by passing the fuel coming from the filter passing the device with the ceramic elements and the magnetic field inside the device.

The most important benefit of the present device is the reduction of fuel consumption in both gasoline and diesel vehicles. The device increases engine efficiency; a higher engine efficiency goes along with a lower fuel consumption. At the same time, the device increases combustion efficiency, this resulting in an improvement of emission values. Altogether, the use of the device of the present invention resides in a lower fuel consumption, a better fuel combustion and improved emissions.

The device of the invention comprises a housing in the form of a tube. The housing has a bottom cover and a top cover, both having a grommet for connection with the fuel line of a vehicle. The top cover faces the fuel filter and the bottom cover the fuel pump. Both covers close the housing fuel tight. The liquid tight sealing is best achieved by means of O-rings. In order to secure the bottom and top cover at the ends of the housing, it is preferred to provide them with a threading, that allows screw them into the ends of the housing.

The wall thickness of the housing corresponds to the diameter of the inside elements.

Within the housing, there are arranged-starting at the bottom cover side—the magnetic zone, the first ceramic element and at least one second ceramic element. The housing is closed by the top and bottom covers, which both have a central sprout for insertion into a fuel line.

The magnetic zone includes a multitude of magnetic elements and a multitude of spring coils, which are both arranged longitudinally and in an alternating mode. Preferred are three to six magnetic elements and three to six spring coils in an alternating arrangement that form a ring around a central passage. The magnetic elements are preferably formed of neodym magnets. The magnetic elements can have the shape of a rod, but may also be composed of a number of single magnets stacked one behind the other, wherein preferably the magnets have a round shape with a central bore. The magnets of a magnetic element are connected to each other by means of a rod or staff arranged inside the bores. The spring coils are preferably made from steel, which may be magnetizable. The use of stainless steel is preferred.

The elements of the magnetic zone are compressed between two plates with a central passage. The staffs of each magnetic element are secured outside plates by means of nuts screwed on threads at the end of the staffs. The staffs are preferably made from brass.

The first and second ceramic elements consist of a fuel resistant ceramic material, such as zirconium oxide, aluminium oxide or the like, and is designed to let fuel pass through. The first ceramic elements therefore comprises a multitude of through bores, which preferably have an inclined course in order to create a vortex. The number and diameter of bores corresponds to the diameter capacity of the fuel line. The second ceramic elements have a central channel with an irregular formed wall to cause turbulence within the fuel flow. The irregularities may be in the form of protrusions and recesses of the inner wall of the second ceramic elements. It is preferred to arrange a multitude of second ceramic elements one after the other, for example three to six.

According to a preferred embodiment of this invention, a second ceramic element is arranged within a bore of the bottom cover.

In order to secure the individual elements of the device of the invention within the housing, a number of clips and distance elements are located in between the individual elements.

In liquid fuels, hydrocarbons are arranged in the form of more or less aligned chains. This arrangement in clusters is detrimental to a smooth combustion in the cylinder of a motor vehicle;

the oxygen needed for combustion has difficulties to enter such cluster, which results in an incomplete combustion and formation of carbon monoxide and zoot. Breaking up such clusters mechanically by means of the ceramic elements and in the magnetic zone by polarisation enhances combustion, which results in a lower zoot formation and lower carbon monoxide. At the same time, less fuel is needed to provide the requested power. It has been found that a fuel reduction up to 5% can be reached and the air fuel relation can be increased by all up to 8%. Cleaner combustion and less fuel consumption result in less and cleaner exhaust emissions.

### BRIEF DESCRIPTION OF THE SEVERAL VIEWS OF THE DRAWING(S)

The invention is further explained by the attached drawings of preferred embodiments showing

FIG. 1 the housing with its individual elements;

FIG. 2 the elements forming the magnetic zone;

FIG. 3 the individual elements of the bottom cover and the magnetic zone;

FIG. 4 a sectional view of the device of the invention; and

FIG. 5 the housing and its elements before insertion into the housing.

### DESCRIPTION OF SPECIFIC EMBODIMENTS OF THE INVENTION

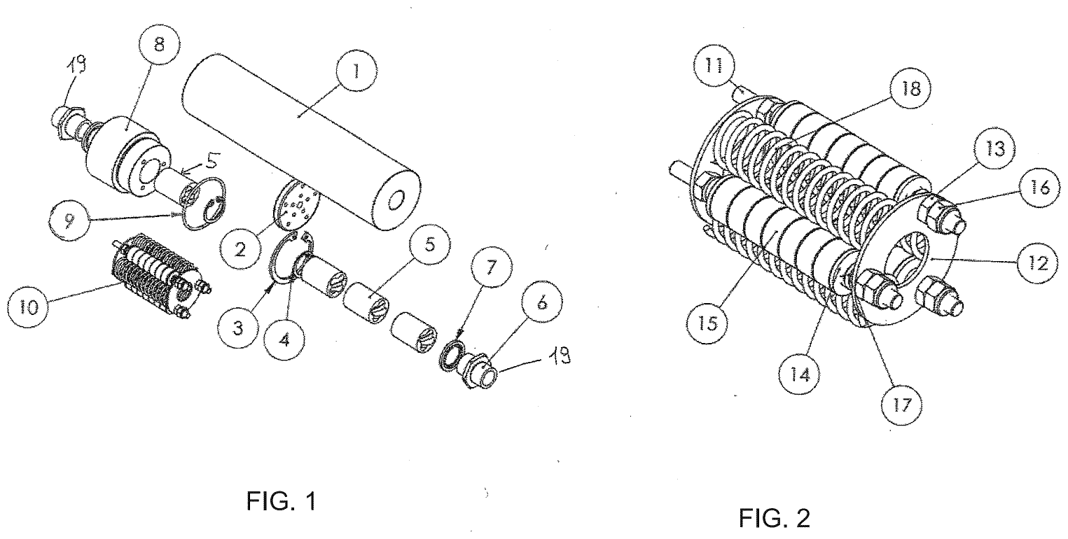

FIG. 1 shows the individual parts of a device according to the invention. The housing 1 is in the form of the tube with a closed top end with a central opening. At the bottom and top ends are shown sprouts 19 to be screwed into the bottom cover 8 and at the top cover 6 at the top end of housing 1, respectively. A ceramic element 5 is for insertion into a central passage in the bottom cover 8. Bottom cover 8 has a circumferential recess, which is preferably threaded to be screwed into the bottom end of housing 1 an O-ring 9 be slipped on the recess of bottom cover 8 provides liquid tightness between housing 1 and bottom cover 8. Subsequent to bottom cover 8 and the second ceramic element 5 inserted into the bottom cover 8 the magnetic zone 10 is located. Upstream from the magnetic zone 10 follows the first ceramic element 2, clips 3 and 4 for stabilising and fixing subsequent second ceramic elements 5. At the top end follows the top cover 6, which is screwed into the central opening at the top end of housing 1. An O-ring 7 provides liquid tightness between housing 1 and top cover 6.

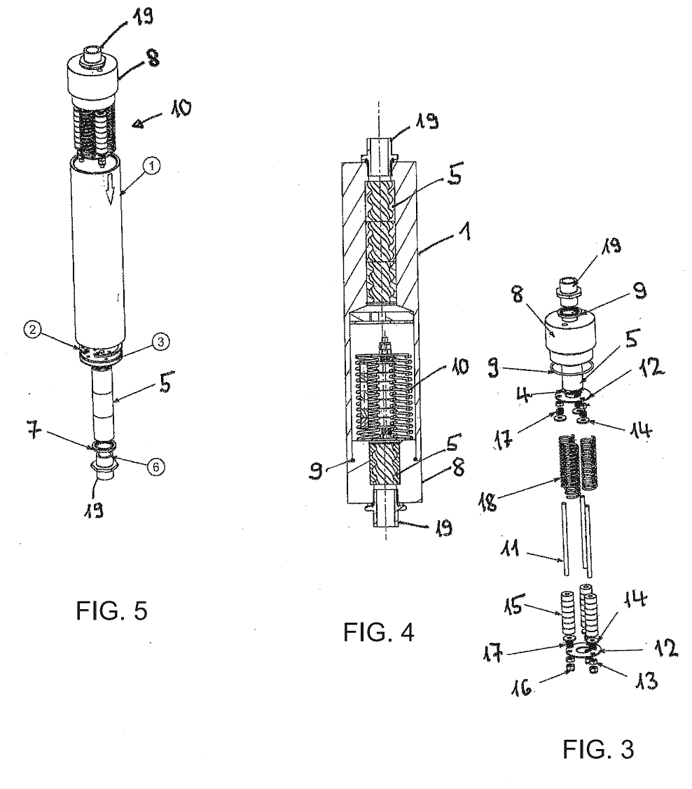

FIGS. 2 and 3 represent the elements constituting the magnetic zone 10. Three magnetic elements 15 are formed by 7 neodym magnets of circular design with a central staff, respectively. The central staff 11 is made from brass and extends through all central holes of the magnets. Three spring coils 18 are arranged between the three magnetic elements in an alternating manner. The spring coils and magnetic elements 15 are contained between plates 12 at both ends. Central holes allow passage of fuel. The staffs 11 are threaded at their ends, protrude through holes in plates12 and are secured on the outside of plates 12 by screws 13 and nuts 16. Copper plates 14 terminating the magnetic elements 15 on both ends break contact of the magnetic elements 15 with plates 12. Between copper plates 14 and plates 12 small springs are located.

FIG. 4 is a longitudinal section of a device according to the invention. The housing 1 is designed in accordance with the space requirements of the elements housed therein. At the top, top cover 6 with sprout 19 is screwed into a central hole of housing 1. Subsequently, there are arranged three second ceramic elements 5, which are closely surrounded by the wall of housing 1. Downwards to the bottom end, housing 1 widens to take up the first ceramic element 2 secured by clips 4 and 3.

Subsequently, the magnetic zone 10 is located followed by the bottom cover 8 having a central passage, into which a second ceramic element 5 is inserted. Bottom cover 8 is screwed into housing 1 at its bottom end, and a sprout 19 is screwed into the bottom end of bottom cover 8. An O-ring 9 is shown at the bottom end of housing 1.

FIG. 5 shows a device according to the invention with a housing 1; the bottom cover 8 with adjacent magnetic zone 10 at the top and the first and second ceramic elements with the top cover 6 and sprout 19 at the bottom of the presentation.

The device of the invention has a length of about 12 to 2 cm and a width of 2 to 3 cm. It can be easily inserted into the fuel line of any motor vehicle between the fuel filter and the fuel pump.

The grooved channel structure of the ceramic parts of the inventive device are suited to cause turbulence within the fuel fed to the device before entering into the magnetic zone. This provides a pre-dispersion of the hydrocarbon structures and clusters in the fuel. The magnetic field acts on the fuel and this action is maximized by the arrangement of the elements within the device. In particular, the spring coils between the magnets increase the magnetic field applied to the fuel. Altogether, this enhances the combustion process within the cylinders and results in a lower fuel consumption and cleaner combustion.

1. Device for optimizing fuel combustion in combustion engines comprising
a housing,
a top cover having a grommet for connection with a fuel line,
a bottom cover having a grommet for connection with a fuel line,
a first ceramic element having a multitude of bores,
at least one second ceramic element having a contorted through channel, and
a magnetic zone with a multitude of magnetic elements and a multitude of spring coils, both arranged alternate and longitudinally.

2. The device of claim 1, wherein the magnetic zone comprises three to six longitudinally arranged magnetic elements, each magnetic element having a rod-shape.

3. The device of claim 1, wherein the magnetic zone comprises three to six longitudinally arranged magnetic elements, each consisting of a multitude of round magnets with a central bore threaded on a staff.

4. The device of claim 1, with three to six longitudinally arranged spring coils, the magnetic elements and the spring coils forming a circle around a central passage through the magnetic zone.

5. The device of claim 1, wherein the elements of the magnetic zone are contained between plates with a central passage, the magnetic elements being secured at both ends of each staff by means of nuts.

6. The device of claim 1, wherein the magnets of the magnetic elements are neodym magnets.

7. The device of claim 1, wherein the magnetic zone is located between the first ceramic element and the bottom cover.

8. The device of claim 1, with a multitude of second ceramic elements.

9. The device of claim 8, wherein the bottom cover houses a second ceramic element in a central passage.

10. The device of claim 1, wherein the bores of the first ceramic element have an inclined course.

11. The device of claim 1, wherein the housing is threaded at the top and bottom end thereof to screw in the top and bottom cover.

12. The device of claim 11, with O-rings providing fuel tightness between the top and bottom cover and the housing, respectively.

13. The device of claim 1, wherein the housing provides a narrow passage for the second ceramic elements.

14. The device of claim 11, with clips for fixation of the first and second ceramic element against the inner wall of the housing.
